(19) United States
(12) Patent Application Publication
(10) Pub. No.: US 2007/0176737 A1
(43) Pub. Date: Aug. 2, 2007

(54) DEVICE FOR ACTUATING A VEHICLE DOOR LOCKING SYSTEM

(76) Inventor: Marco Friese, Dusseldorf (DE)

Correspondence Address: FORD GLOBAL TECHNOLOGIES, LLC, FAIRLANE PLAZA SOUTH, SUITE 800, 330 TOWN CENTER DRIVE, DEARBORN, MI, 48126, US

(21) Appl. No.: 11/622,826

(22) Filed: Jan. 12, 2007

(30) Foreign Application Priority Data
Jan. 13, 2006 (DE) 102006001719.6

(51) Int. Cl. G05B 19/00

(52) U.S. Cl. 340/5.61; 340/5.72

(57) ABSTRACT

The invention relates to a device for actuating a vehicle door locking system, having a portable identification unit (10) and a vehicle-mounted control device (20) which, when the identification unit moves closer, generates, on the basis of the result of a contactless data communication between the control device and the identification unit for checking the access authorization for the identification unit, a control signal for unlocking the vehicle door locking system if the presence of the access authorization for the identification unit has been detected. The vehicle-mounted control device is configured in such a way that when a person approaches the contactless data communication is triggered when the distance between the person and a person sensor (23) drops below a first finite distance (d₁), and after successful identification of the identification unit the control signal for unlocking the locking device is generated when the person has reached a second finite distance (d₂) from a predefined location on the vehicle which is smaller than the first distance.

The invention relates to a device for actuating a vehicle door locking system.

Devices for actuating a vehicle door locking system in which unlocking takes place after previous electronic checking of the access authorization and as a function of satisfactory data communication between a signal processing device which is provided at the vehicle end and a mobile, user-end key device are known, for example, from DE 103 30 807 A1, DE 1002 38 134 A1 and EP 1 023 511 B1.

EP 0 952 052 B1 discloses a device for a remote-controlled access control device which comprises a transportable identification signal transmitter and a transmitter and receiver unit arranged in or on the vehicle. When there is a positive identification of the identification signal transmitter on the basis of a radiofrequency communication which is carried out for this purpose, this transmitter and receiver unit transmits a control signal to a locking unit. The locking unit is not actuated, in order to lock or unlock the vehicle, until it is actuated by a further sensor system, for example in the form of a contact sensor. This is intended to ensure that, in addition to the approach of the motor vehicle driver to the vehicle, a further intentional action is necessary, in which case, on the one hand, inadvertent unlocking of the vehicle is to be avoided (for example if the driver of the motor vehicle passes the vehicle), and, on the other hand, access is also to be impossible solely on the basis of position of the identification signal transmitter, in particular for a third party without knowledge of which intentional action is to be performed.

However, with this known device the unlocking of the vehicle is not initiated until the respective intentional action is performed so that the associated time period required for the unlocking process either has to be accepted as wasted time or complex and costly locking devices have to be used to minimize this time period.

The object of the present invention is to make available a device for actuating a vehicle door locking system which permits rapid unlocking of the vehicle door even if relatively simple locking devices are used.

A device according to the invention for actuating a vehicle door locking system comprises, according to the generic type, a portable identification unit and a vehicle-mounted control device which, when the identification unit moves closer, generates, on the basis of the result of a contactless data communication between the control device and the identification unit for checking the access authorization for the identification unit, a control signal for unlocking the vehicle door locking system if the presence of the access authorization for the identification unit has been detected.

The vehicle-mounted control device is configured in such a way that
when a person approaches the contactless data communication is triggered when the distance between the person and a person sensor drops below a first finite distance, and
after successful identification of the identification unit the control signal for unlocking the vehicle door locking device is generated when the person has reached a second finite distance from a predefined location on the vehicle which is smaller than the first distance.

The term “vehicle door” in the sense of the present application comprises any device which serves to permit or lock the access to the vehicle, that is to say for example also a tailgate or a trunk lid.

“Distance from a person” in the sense of the present invention is intended to mean, in particular, the distance between a corresponding distance sensor and a body part of the person who is closest to the sensor. As a rule this is the distance between the sensor and the hand or arm of the person who is holding the door or trunk handle.

The generation of the control signal for unlocking the vehicle door locking system takes place automatically without the need for further action on the part of this person when the second finite distance from the person is reached. In this way, the unlocking process is also initiated during the approach of the person and even if a comparatively simple locking device is used (without a particularly short closing period) said unlocking process can already be terminated when the person touches the door handle which is then already unlocked. In the process, the natural movement process which precedes the opening of a vehicle door, i.e. the approaching of one of the driver's hands to the vehicle door including the subsequent hand movement up to the activation of the door handle, can be used both to check the access authorization and for the actual mechanical unlocking process so that the authorized person obtains access to the vehicle without any delay due to the unlocking process, even if comparatively simple locking devices are used.

The undershooting of the second finite distance is detected according to the invention by means of a proximity sensor which is located at the predefined location on the vehicle and which triggers automatically when the second finite distance is undershot, without further action (for example such as in the case of a contact sensor) being necessary or a further identification process (such as for example in the case of a device which recognizes a fingerprint or a face which is proposed according to the prior art) taking place.

The proximity sensor which is used to detect the undershooting of the second finite distance can be located directly in the vicinity of the person sensor or else at a different location on the vehicle. According to one preferred embodiment, both the first proximity sensor and the further proximity sensor are arranged on the door handle of the vehicle door which can be locked or unlocked by means of the vehicle door locking system. It is also possible for just a single distance sensor to be provided which supplies a continuous output signal, in which case the corresponding processes are triggered by comparison with a first and second distance threshold value.

Further refinements of the invention can be found in the description and in the subclaims.

The invention will be described in more detail below with reference to an exemplary embodiment which is illustrated in the appended illustrations, of which:

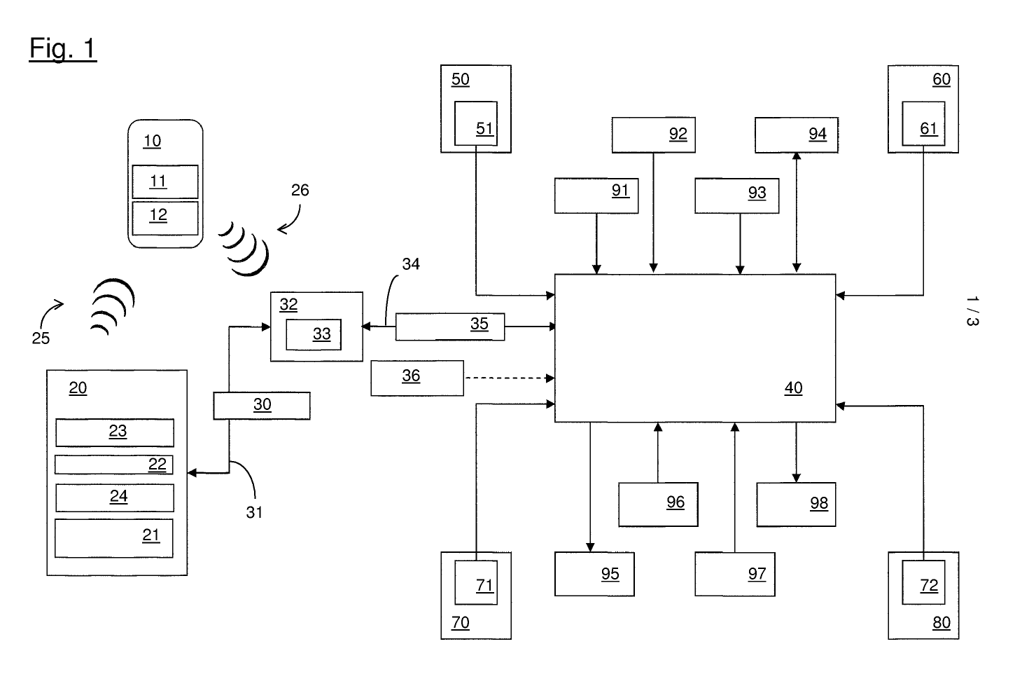

FIG. 1 is a block diagram with the components of a device according to the invention in a preferred embodiment;

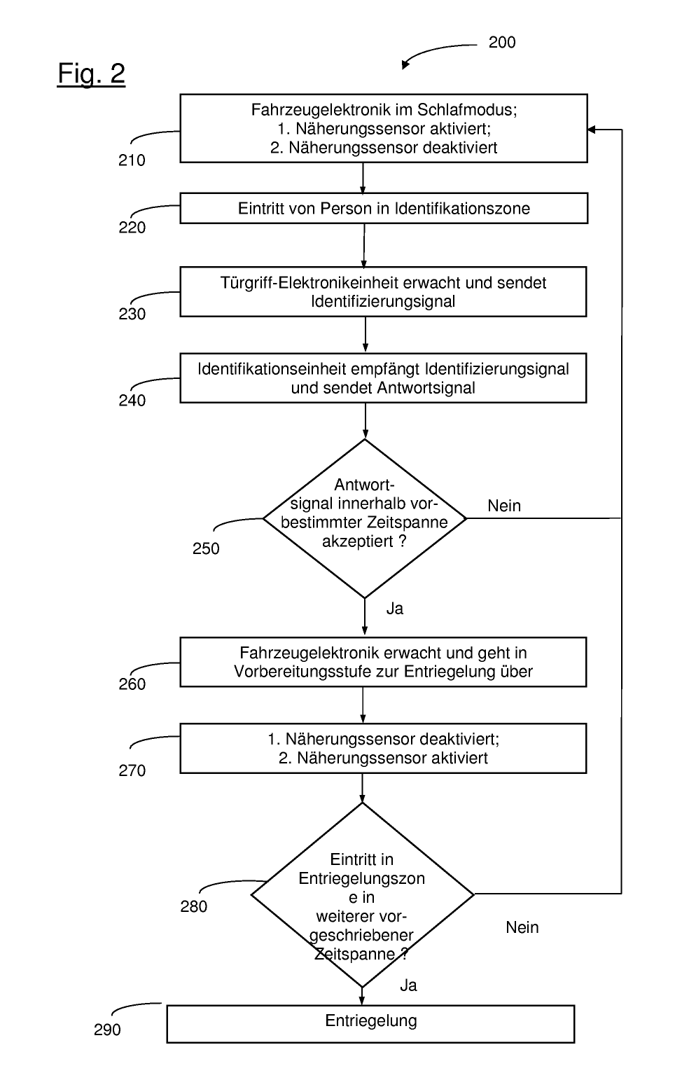

FIG. 2 is a flow chart explaining the method of functioning of the device according to the invention; and

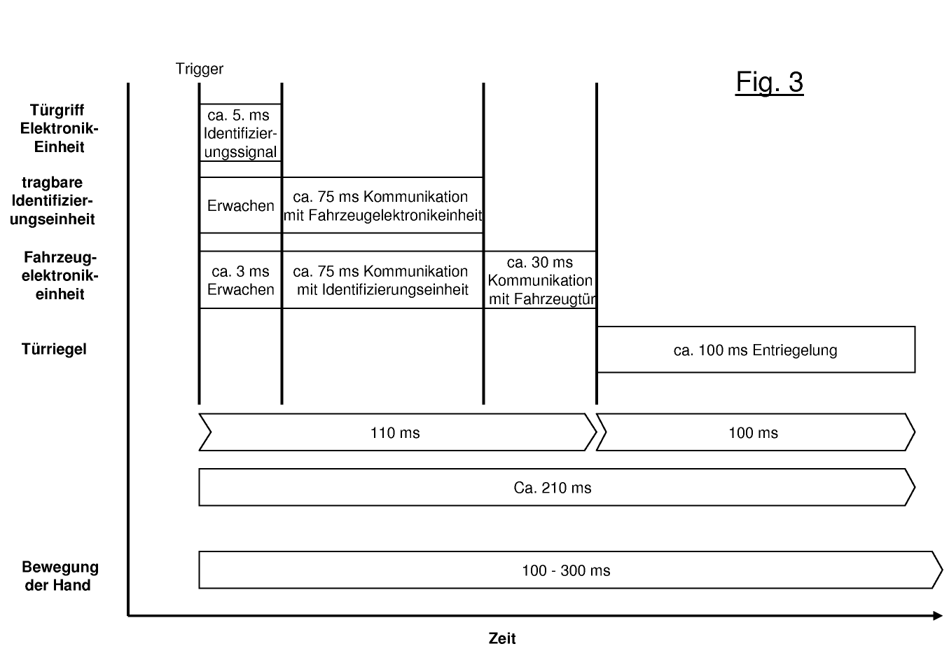

FIG. 3 is a timing diagram for a preferred exemplary embodiment of the device according to the invention.

According to FIG. 1, a device according to the invention for actuating a vehicle door locking system comprises a portable identification unit 10 (configured for example as a key tag) with a first receiver unit 11 and a first transmitter unit 12. The device also comprises a door handle electronic unit 20 which is provided on each vehicle door to be actuated and which has a power supply unit 21 and a second transmitter unit 22.

The door handle electronic unit 20 also has a first proximity sensor 23 and a second proximity sensor 24. According to the invention, different selections are made for the detection zones of the proximity sensors 23 and 24, i.e. those zones within which an approaching object causes the respective proximity sensor 23 or 24 to respond (for example as a result of a threshold value which is defined along a characteristic curve of the respective proximity sensor 23 or 24 being exceeded by the sensor signal). To be more precise, the first proximity sensor 23 responds when a person enters what is referred to as an identification zone, which is the case if the person undershoots (typically with the hand) a first distance d₁ from the first proximity sensor 23. This first distance d₁ is typically in the range from approximately 10 to 20 cm and is preferably approximately 15 cm. The second proximity sensor 24 responds when a person enters what is referred to as an unlocking zone, which is the case if the person (typically also with the hand) undershoots a second distance d₂ from the second proximity sensor 24 which is significantly shorter than the first distance. This second distance d₂ is typically less than 5 cm and is preferably less than the extent of the intermediate space remaining between the door handle and the door surface so that the second proximity sensor 24 triggers, for example, if the person's hand engages in this intermediate space with an intention to open the door.

The door handle electronic unit 20 is connected via a databus 31, running via a bidirectional interface 30, to a second receiver unit 32 with a controller 33, and this second receiver unit 32 is connected to the central vehicle electronic unit 40 via a databus 34 which runs via a further bidirectional interface 35. The second vehicle electronic unit 40 is connected to the unlockable vehicle doors (vehicle door 50 with locking device 51, front seat passenger's door 60 with locking device 61, left-hand rear door 70 with locking device 71 and right-hand rear door 80 with locking device 81), as well as various further vehicle components (in the example ISS 91, engine hood 92, radio 93, BBS 94, horn 95, tailgate 96, rear window heater 97 and flashing indicator light 98 etc.).

Reference will be made below to the flowchart 200 shown in FIG. 2 in order to explain the method of functioning of the device according to the invention.

According to FIG. 2, the vehicle electronic system is initially in the sleep mode in the state as illustrated in block 210 when the vehicle is parked and locked. In this state, the first proximity sensor 23 is activated, as a result of which penetration of a person into the identification zone is monitored and the second proximity sensor 24 is deactivated.

If, according to block 220, a person penetrates the identification zone, the first proximity sensor 23 responds, in response to which, according to block 230, the door handle electronic unit 20 is woken up and the transmitter unit 22 which is associated with the door handle electronic unit 20 emits an identification signal 25 (first signal). If the person who has entered the identification zone carries an identification unit 10 on their person, the identification signal 25 is received from the receiver unit 11 which is associated with said identification unit 10, the signal being able to contain a first cryptographic key. The transmitter device 12 which is associated with the identification unit 10 transmits, according to block 240, a response key 26 (second signal) which is received and checked by the second receiver unit 32 (block 250). The response key is, as is already known in the prior art, calculated in the ID unit from the first cryptographic key by means of an algorithm which cannot be followed from the outside. In the vehicle, this calculation is also carried out and it is checked whether the received response key corresponds to the anticipated key. In this way, it is also impossible for monitoring of the communication between the vehicle and ID unit to be used to produce a “simulated key”. In one preferred embodiment, the signal transfer between the door handle electronic unit 20 and the portable identification unit 10 can also be carried out in a capacitive fashion, for example between the door handle surface and an input element, provided on the portable identification unit 10 and in the form, for example, of an electrode surface which extends on the housing of the identification unit 10. In addition, the first proximity sensor 23 can at the same time be embodied as an antenna for transmitting signals during the data communication between the control device 20 and the identification unit 10.

If the response signal 26 is not accepted within a prescribed time period, the vehicle electronic system goes back into the sleep mode by returning to block 210. If, on the other hand, the response signal 26 is accepted within the prescribed time period, the vehicle electronic unit 40 is activated, and said vehicle electronic unit 40 already goes into a preparatory stage for unlocking the respective vehicle door 50, 60, 70 or 80 (for example it is possible to energize corresponding solenoids or activating motors for the unlocking process without the corresponding unlocking process already being triggered). At the same time, or shortly afterwards, according to block 270 the first proximity sensor 23 is deactivated and the second proximity sensor 24 is activated, as a result of which penetration of a person into what is referred to as the unlocking zone is monitored. According to block 280 it is checked whether in a further predefined time period the person also penetrates the unlocking zone (for example whether the person had already penetrated this area at the activation time). If the person does not penetrate the unlocking zone within this further predefined time period, the vehicle electronic unit 40 goes into the sleep mode again by returning to block 210. If, on the other hand, the person also penetrates the unlocking zone within the further predefined time period, the respective vehicle door 50, 60, 70 or 80 (block 290) is unlocked.

A preferred timing diagram for the method of functioning of the device according to the invention is illustrated in FIG. 3. According to this, in this exemplary embodiment, calculated from the response of the first proximity sensor 23, i.e. from the penetration of a person into the identification zone, the entire time period up to the unlocking is approximately 210 ms. Of this time period, the last approximately 100 ms are taken up by the actual mechanical unlocking process, and the first approximately 110 ms are taken up proportionally by the emission of the identification signal 25 by the door handle electronic unit (approximately 5 ms), the reception and the checking of the response signal 26 (approximately 75 ms) and the communication with the central vehicle electronic unit 40 and the vehicle door (30 ms). The typical time period between the first penetration of the person into the identification zone (i.e. the undershooting of the first distance d₁) and the activation of the door handle were determined as being approximately 100 to 300 ms by reference to tests. Consequently, by means of the device according to the invention it is possible to use the natural movement process, i.e. the moving of the driver's hand to the vehicle door including the subsequent hand movement up to the activation of the door handle in a virtually optimum way for checking the access authorization and for the actual mechanical unlocking process so that as a result rapid unlocking of the vehicle door is made possible even when relatively simple locking devices are used. Within the scope of the invention it is also possible to use tendencially slower transmission modes, which are less sensitive to faults, for the wireless communication between the ID unit and the vehicle without a decrease in comfort levels since the identification process is carried out in a virtually predictive fashion. Since the actual unlocking process is then preferably not triggered until a relatively close approach, the probability of unintentional unlocking of the vehicle is greatly reduced.

1. A device for actuating a vehicle door locking system, having:
a portable identification unit (10); and
a vehicle-mounted control device (20) which, when the identification unit (10) moves closer, generates, on the basis of the result of a contactless data communication between the control device (20) and the identification unit (10) for checking the access authorization for the identification unit (10), a control signal for unlocking the vehicle door locking system if the presence of the access authorization for the identification unit (10) has been detected, wherein the vehicle-mounted control device (20) is configured in such a way that:
when a person approaches the contactless data communication is triggered when the distance between the person and a person sensor (23) drops below a first finite distance (d₁), and
after successful identification of the identification unit (10) the control signal for unlocking the locking device is generated when the person has reached a second finite distance (d₂) from a predefined location on the vehicle which is smaller than the first distance (d₁).

2. The device as claimed in claim 1, wherein the person sensor (23) is arranged in the door, tailgate and/or trunk handle.

3. The device as claimed in claim 1 or 2, wherein the person sensor (23) is embodied at the same time as an antenna for transmitting signals during data communication between the control device (20) and the identification unit (10).

4. The device as claimed in one of claims 1 to 3, wherein a signal transfer takes place between the identification unit (10) and the vehicle-mounted control device (20) in a capacitive fashion.

5. The device as claimed in one of the preceding claims, characterized in that in addition to the person sensor (23) which is configured as a first proximity sensor a second proximity sensor (24) is arranged at the predefined location on the vehicle, preferably in the door, tailgate and/or trunk handle.

6. The device as claimed in one of the preceding claims, wherein the generation of the control signal for unlocking the vehicle door locking system takes place automatically without further action by the person when the second finite distance (d₂) is reached and after successful identification of the identification unit (10).

7. The device as claimed in one of the preceding claims, wherein the first distance (d₁) is in the range from 10 to 20 cm and is preferably approximately 15 cm.

8. The device as claimed in one of the preceding claims, wherein the second distance (d₂) is less than 5 cm.

9. The device as claimed in one of the preceding claims, wherein the second distance (d₂) is less than the extent of the intermediate space remaining between the door handle and door surface.
